(19) United States
(12) Patent Application Publication
(10) Pub. No.: US 2013/0040510 A1
(43) Pub. Date: Feb. 14, 2013

(54) CONNECTOR

(71) Applicants: Shinichi Ishizuka, Tokyo (JP); Ryosuke Soejima, Tokyo (JP)

(72) Inventors: Shinichi Ishizuka, Tokyo (JP); Ryosuke Soejima, Tokyo (JP)

(21) Appl. No.: 13/570,356

(22) Filed: Aug. 9, 2012

(30) Foreign Application Priority Data
Aug. 9, 2011 (JP) 2011-174150
May 10, 2012 (JP) 2012-108942

(51) Int. Cl. H01R 4/10

(52) U.S. Cl. 439/877

(57) ABSTRACT

A connector includes: a first contact part; a second contact part; and an elastic deformable part provided between the first and second contact parts, the elastic deformable part comprising: at least one rounding part which rounds less than one circle around a phantom line interconnecting a base position of the first contact part and a base position of the second contact part; a connecting part which is extended from one end of the rounding part to the first contact part; and a connecting part which is extended from the other end of the rounding part to the second contact part.

### BACKGROUND OF THE INVENTION

The present invention relates to a connector which is provided on a printed board, for example, to be used for electrically interconnecting a conductor pattern such as a ground pattern and a wiring pattern of the printed board and a conductive pattern of another printed board or a shield case.

FIG. 32 is an outlook view of a related-art connector of a leaf spring type for obtaining elasticity by folding a metallic plate, when it is mounted on a board (also refer to JP-A-2004-192962). This connector is mounted on a circuit board 2 by soldering or so, in such a manner that a mounting face 813 functions as a contact face, and a contact part 814 is adapted to be contacted with a shield case. Elasticity of an elastically deformable part 815 functions as a contact force.

FIG. 33 is an outlook view of a related-art pin connector for obtaining elasticity by compression of a coil spring, when it is mounted on a board. This connector is mounted on a circuit board 2 by soldering or so, in such a manner that a mounting face 813 functions as a contact face, and a tip end of a pin 804 is adapted to be contacted with a shield case. Elasticity of a spring 806 functions as a contact force.

Although the connector of the leaf spring type as shown in FIG. 32 is advantageous in that it can be formed of one component at minimum, the connector is disadvantageous in that it occupies a large area of the board, in case where a contact position is made higher. The pin connector as shown in FIG. 33 is more advantageous than the connector of the leaf spring type in FIG. 32 in that it does not occupy a large area of the board, even in case where the contact position is high. However, the pin connector is disadvantageous in that it requires at least three components, specifically, the coil spring, the pin as the contact, and additionally, a tube for holding and mounting them on the circuit board, and thus, incurs a high cost.

### SUMMARY

This invention provides a connector capable of attaining both a small number of components and space saving performance.

An aspect of the invention provides a connector comprising: a first contact part; a second contact part; and an elastic deformable part provided between the first and second contact parts, the elastic deformable part comprising: at least one rounding part which rounds less than one circle around a phantom line interconnecting a base position of the first contact part and a base position of the second contact part; a connecting part which is extended from one end of the rounding part to the first contact part; and a connecting part which is extended from the other end of the rounding part to the second contact part.

The rounding part may include a plurality of rounding parts, the plurality of rounding parts may be arranged at different positions from each other with respect to a direction of the phantom line, and ends of adjacent two of the plurality of rounding parts may be connected by a connecting part.

The plurality of rounding parts may round around the phantom line more than one circle.

Angular positions of the connecting parts with respect to the phantom line may be different from each other, as seen from the direction of the phantom line.

The connecting parts may be positioned at a substantially equiangular interval with respect to the phantom line, as seen from the direction of the phantom line.

The rounding part may round around the phantom line more than a half circle.

The first contact part may be a base part one face of which is a mounting face, and the base part may be connected to the rounding part by the connecting part which is extended from the one end of the rounding part. The second contact part may be a distal end part having a projected distal end part which is directed to an opposite side to the mounting part, and the distal end part may be connected to the rounding part by the connecting part which is extended from the other end of the rounding part.

The connector may further comprise: a butting part which is erected from the base part and which is extended toward the distal end part. The butting part may be butted against a face of the distal end part, when the connector is compressed.

The butting part may be bent from the base part to be erected, and is positioned inside the rounding part, as seen from a direction of the phantom line.

The connecting part which is extended from the other end of the rounding part may have a larger width than the connecting part which is extended from the one end of the rounding part.

The rounding part may exist within a plane which is substantially perpendicular to the phantom line, and the connecting parts may be bent from the rounding part to extend substantially in parallel with the phantom line.

The rounding part may round around the phantom line in a shape of an arc, making the phantom line as an axis.

The connector may be formed by folding a sheet of conductive plate material.

The phantom line may interconnect a center of the first contact part and a center of the second contact part, or centers of smallest inclusion circles of contact parts with respect to objects to be contacted.

It is to be noted that a desired combination of the above described constituent elements, and descriptions of the invention which are exchanged between methods and systems are also effective as features of the invention.

### BRIEF DESCRIPTION OF THE DRAWINGS

FIG. 1 is a perspective view of a connector according to Embodiment 1 of the invention, in an extended state.

FIG. 2 is a perspective view of the connector in a compressed state.

FIG. 3 is a front view of the connector in the extended state.

FIG. 4 is a plan view of the connector in the extended state.

FIG. 5 is a bottom view of the connector in the extended state.

FIG. 6 is a left side view of the connector in the extended state.

FIG. 7 is a right side view of the connector in the extended state.

FIG. 8 is a back view of the connector in the extended state.

FIG. 9 is a sectional view taken along a line X-X in FIG. 7.

FIG. 10 is a sectional view taken along a line Y-Y in FIG. 7.

FIG. 11 is a sectional view taken along a line Z-Z in FIG. 7.

FIG. 12 is a front view of the connector as shown in FIG. 1 in a state mounted on a circuit board.

FIG. 13 is a perspective view of a connector according to Embodiment 2 of the invention, in an extended state.

FIG. 14 is a plan view of the connector in the extended state.

FIG. 15 is a perspective view of the connector in a compressed state.

FIG. 16 is a perspective view of a connector according to Embodiment 3 of the invention, in an extended state.

FIG. 17 is a plan view of the connector in the extended state.

FIG. 18 is a perspective view of the connector in a compressed state.

FIG. 19 is a perspective view of a connector according to Embodiment 4 of the invention, in an extended state.

FIG. 20 is a plan view of the connector in the extended state.

FIG. 21 is a perspective view of the connector in a compressed state.

FIG. 22 is a perspective view of a connector according to Embodiment 5 of the invention, in an extended state.

FIG. 23 is a plan view of the connector in the extended state.

FIG. 24 is a perspective view of the connector in a compressed state.

FIG. 25 is a perspective view of a connector according to Embodiment 6 of the invention, in an extended state.

FIG. 26 is a plan view of the connector in the extended state.

FIG. 27 is a perspective view of the connector in a compressed state.

FIG. 28 is a perspective view of a connector according to Embodiment 7 of the invention, in an extended state.

FIG. 29 is a perspective view of the connector in a compressed state.

FIG. 30 is a plan view of the connector in the compressed state.

FIG. 31 is a side view of the connector as seen from a direction of an arrow mark A.

FIG. 32 is an outlook view of a related-art connector of a leaf spring type for obtaining elasticity by folding a metallic plate, when it is mounted on a board.

FIG. 33 is an outlook view of a related-art pin connector for obtaining elasticity by compressing a coil spring, when it is mounted on a board.

### DETAILED DESCRIPTION OF EMBODIMENTS

Now, preferred embodiments of the invention will be described in detail, referring to the drawings. It is to be noted that the same or equivalent constituent elements and members which are shown in the respective drawings will be denoted with the same reference numerals, and overlapped descriptions will be adequately omitted. Moreover, the embodiments do not limit the invention, but only exemplify the invention. All features described in the embodiments and combinations of the features are not necessarily essential to the invention.

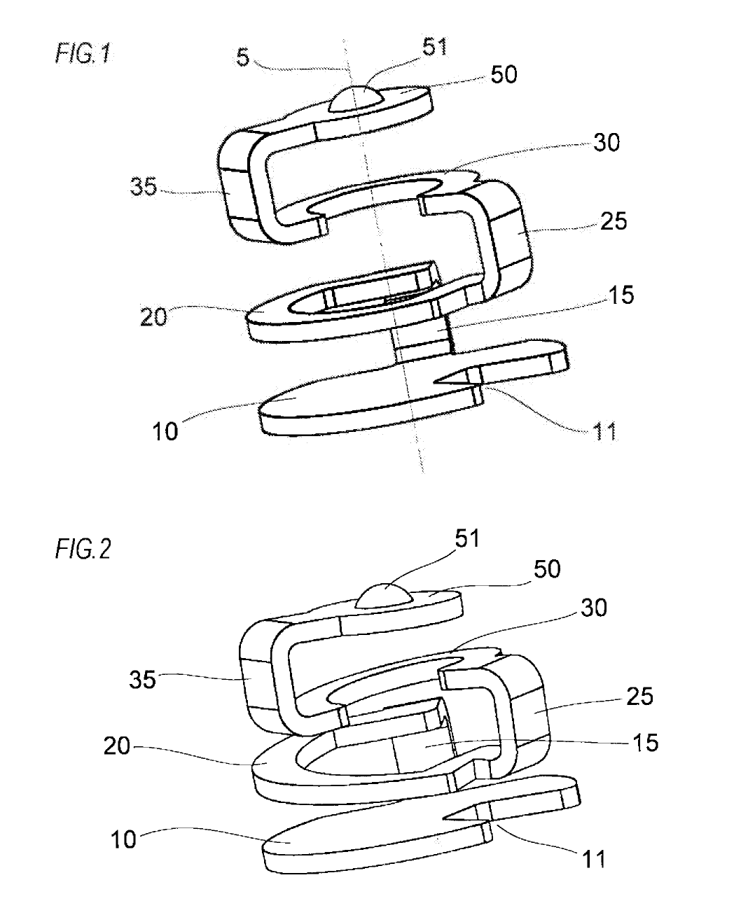

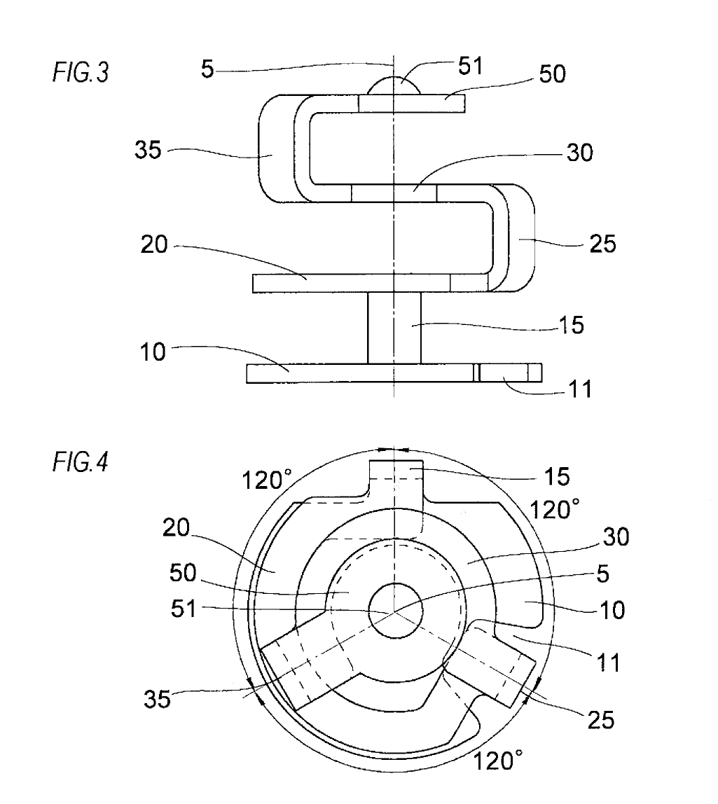

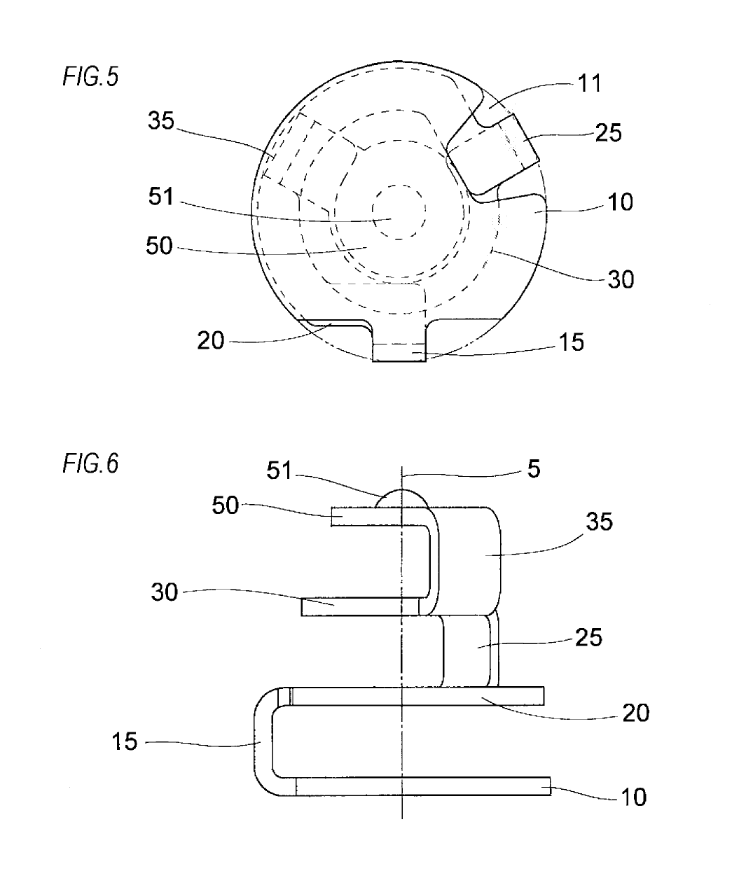

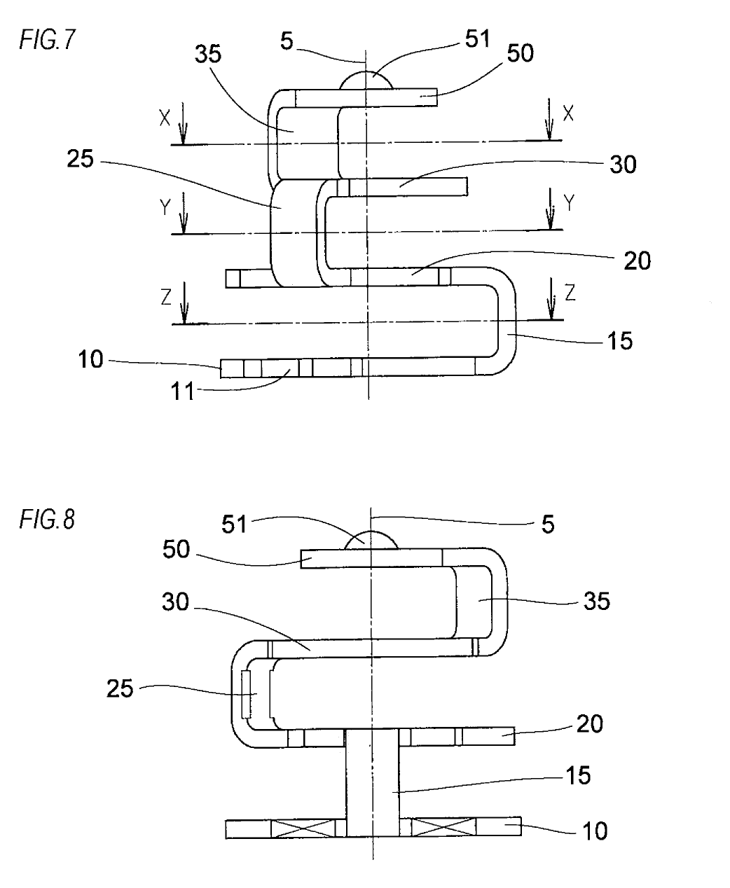

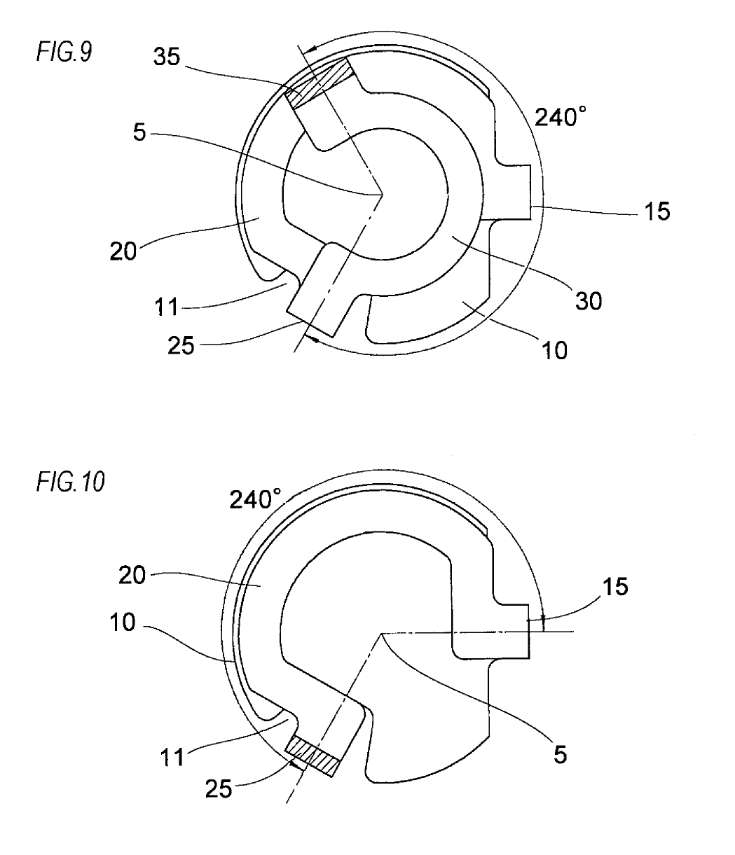

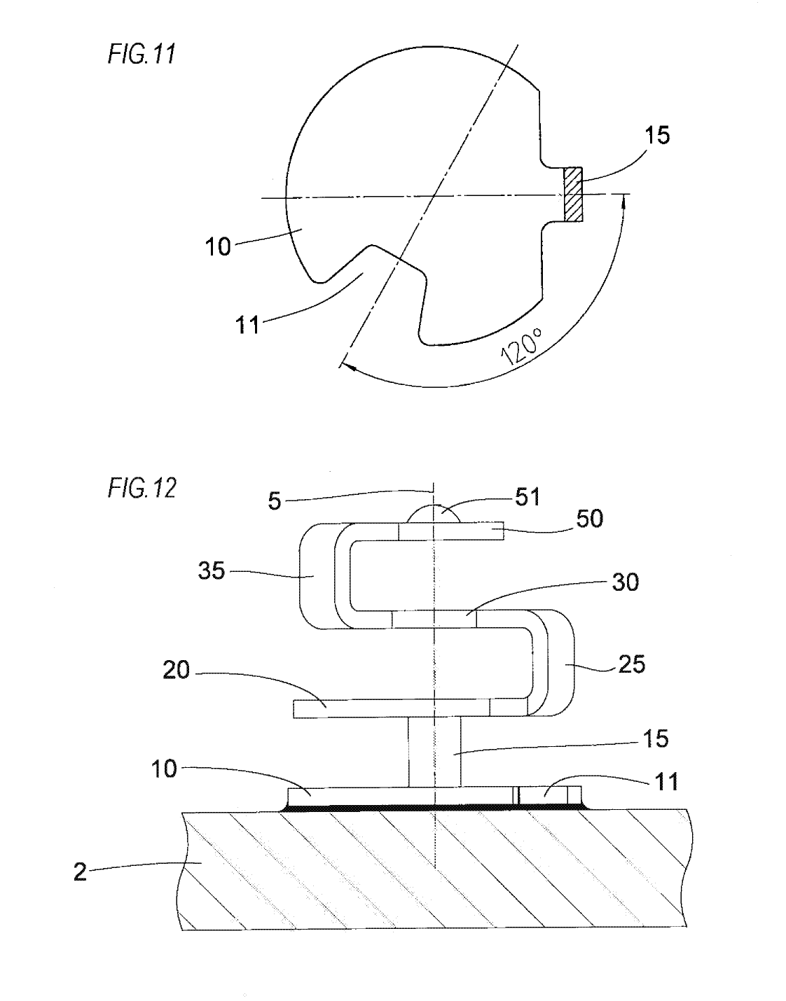

FIG. 1 is a perspective view of a connector according to Embodiment 1 of the invention, in an extended state. FIG. 2 is a perspective view of the connector in a compressed state. FIG. 3 is a front view of the connector in the extended state. FIG. 4 is a plan view of the same, FIG. 5 is a bottom view of the same, FIG. 6 is a left side view of the same, FIG. 7 is a right side view of the same, and FIG. 8 is a back view of the same. FIG. 9 is a sectional view taken along a line X-X in FIG. 7, FIG. 10 is a sectional view taken along a line Y-Y in FIG. 7, and FIG. 11 is a sectional view taken along a line Z-Z in FIG. 7.

The connector in this embodiment includes a base part 10, a first connecting part 15, a first rounding part 20, a second connecting part 25, a second rounding part 30, a third connecting part 35, and a distal end part 50. These parts are formed of a sheet of conductive plate material such as phosphor bronze (a metallic plate) by stamping and folding work. The base part 10 and the distal end part 50 function as contact parts at both ends of the connector in this embodiment. The other parts constitute a fictitious spring structure, and functions as an elastic deformable part.

In the connector in this embodiment, a rectilinear line which interconnects a base position of the base part 10 and a base position of the distal end part 50 is defined as a phantom line 5. In this embodiment, specifically, the phantom line 5 interconnects a center of the base part 10 and a center of a projected distal end part 51. Each of the base positions are not limited to the centers. In this embodiment, the center of the base part 10 is determined without considering a cutout part 11, and the phantom line 5 passes a center of a minimum inclusion circle of a mounting face (a bottom face) of the base part 10. It is to be noted that the minimum inclusion circle means the smallest circle out of those circles that contains the bottom face of the base part 10 inside. Specifically, in case where an outer shape of the bottom face of the base part 10 is a circle, the outer shape is the minimum inclusion circle. In case where the projected distal end part 51 comes into face contact with a counterpart, the phantom line 5 may be so defined as to pass a center of the minimum inclusion circle of a contact face of the distal end part 50, in the same manner.

The base part 10 is in a substantially disc-like shape having the cutout part 11, and provided substantially perpendicularly to the phantom line 5. The bottom face of the base part 10 is a mounting face to be mounted on a circuit board 2, as shown in FIG. 12. The first connecting part 15 in a shape of a rectangular plate is bent substantially vertically from an edge of the base part 10 thereby to be erected substantially in parallel with the phantom line 5 with its one face directed to the phantom line 5. An upper end of the first connecting part 15 is bent substantially perpendicularly, and the first rounding part 20 is extended from the bent part. In other words, the first connecting part 15 is bent from one end of the first rounding part 20 to be extended toward the base part 10.

The first rounding part 20 is an arc-shaped flat plate which rounds around the phantom line 5 as a center axis, from its one end to the other end, which will be described below. A rounding angle is about 240 degree, as apparent from FIG. 10. A plane where the first rounding part 20 exists is substantially perpendicular to the phantom line 5 (substantially parallel to the base part 10). The second connecting part 25 in a shape of a rectangular plate is bent substantially vertically from the other end of the first rounding part 20 thereby to be extended (erected) toward the distal end part 50 substantially in parallel with the phantom line 5 with its one face directed to the phantom line 5. An upper end of the second connecting part 25 is bent substantially perpendicularly, and the second rounding part 30 is extended from the bent part. In other words, the second connecting part 25 is bent from one end of the second rounding part 30 to be extended toward the base part 10.

The second rounding part 30 is an arc-shaped flat plate which rounds around the phantom line 5 as a center axis, from its one end to the other end, which will be described below. A rounding angle is about 240 degree, as apparent from FIGS. 9 and 10. A plane where the second rounding part 30 exists is substantially perpendicular to the phantom line 5 (substantially parallel to the base part 10 and the first rounding part 20). The third connecting part 35 in a shape of a rectangular plate is bent substantially vertically from the other end of the second rounding part 30 thereby to be extended (erected) toward the distal end part 50 substantially in parallel with the phantom line 5. An upper end of the third connecting part 35 is bent substantially perpendicularly, and the distal end part 50 is extended from the bent part. The third connecting part 35 is formed larger in width than the first connecting part 15 and the second connecting part 25.

The distal end part 50 has the projected distal end part 51 which is projected from its center part in a substantially disc-like shape, in an opposite direction to the base part 10. A tip end of the projected distal end part 51 functions as a contact part to come into contact with the counterpart (a conductor pattern of another printed circuit board or a shield case, for example). The projected distal end part 51 is formed, for example, by stamping the distal end part 50 from a back side (a side of the base part 10).

The base part 10, the first rounding part 20, the second rounding part 30 and the distal end part 50 are arranged in such a manner that the planes where they themselves exist may be parallel to each other, and that their positions with respect to the direction of the phantom line 5 are different from each other at predetermined intervals, by means of the first connecting part 15, the second connecting part 25, and the third connecting part 35. In this embodiment, they are arranged at the same interval.

The connector in this embodiment is compressed as shown in FIG. 2, when it is mounted on the circuit board making the bottom face of the base part 10 as the contact face, and the projected distal end part 51 is brought into contact with the counterpart. In this compressed state, an elastic force (a restoring force to be restored to the extended state) is created by a stress attributed to flections of the first rounding part 20, the second rounding part 30 and the distal end part 50, and additionally, by a stress attributed to torsions of the first rounding part 20 and the second rounding part 30. In this manner, a contact force (a contact pressure) to be applied to the counterpart is given to the projected distal end part 51. Specifically, not only a feature of a thin leaf spring mainly utilizing the stress of the flections which are concentrated on the bent parts, but also a feature of a coil spring mainly utilizing the stress of the torsions can be obtained as elastic elements. As the results, it is possible to secure necessary elasticity, thereby allowing the connector to function as a stabilized electrical contact.

According to the embodiment, the following advantages can be achieved.

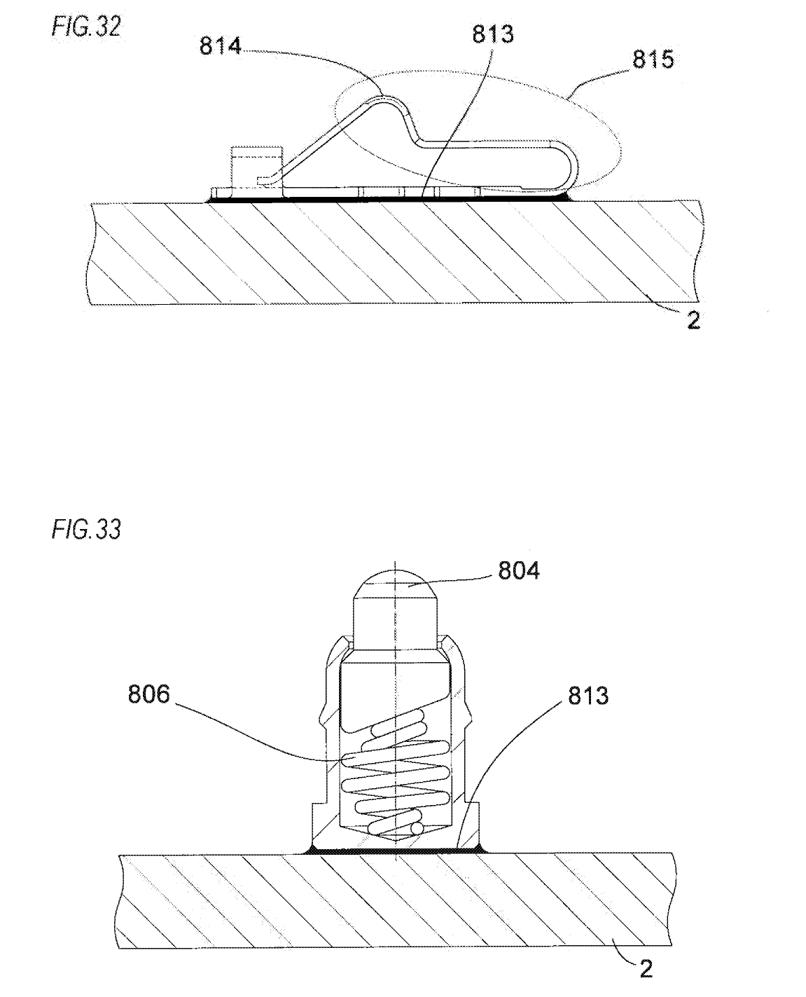

(1) The connector is so constructed that the fictitious spring part composed of the first connecting part 15, the first rounding part 20, the second connecting part 25, the second rounding part 30, and the third connecting part 35 functions as the elastic deformable part. Therefore, as compared with the related-art connector of the leaf spring type as shown in FIG. 32, the contact position can be made higher, without increasing the area of the board to be occupied, and space saving performance can be advantageously attained. Moreover, by realizing an integral structure composed of one component formed of the metallic plate, the number of the components is reduced, and the connector is advantageous in view of the cost, although the connector has substantially the same functions (elasticity and space saving performance) as the related-art pin connector as shown in FIG. 33. As the results, it is possible to realize the connector having both advantages of the space saving performance of the pin connector and the low cost of the leaf spring. In case where this connector is used as a signal contact, for example, in an electronic device such as a mobile phone, it is possible to produce the device at a low cost and with space saving.

(2) Because the first connecting part 15, the second connecting part 25, and the third connecting part 35 are arranged at different angles in a circumferential direction around the phantom line 5, as an axis, these connecting parts do not interfere with each other, when the connector is compressed. Therefore, a necessary compression range as the connector can be sufficiently secured. Moreover, because the connecting parts are arranged at an equiangular interval of 120 degree as seen from the direction of the phantom line, the connector is well balanced on occasion of the compression.

(3) Because the first rounding part 20 and the second rounding part 30 round in a shape of an arc around the phantom line 5, the stresses attributed to the torsions on occasion of the compression are dispersed and equally applied to the arc-shaped parts. For this reason, durability is enhanced, as compared with a case where the stresses are concentrated.

(4) Because the third connecting part 35 has a larger width than the first connecting part 15 and the second connecting part 25, an amount of the flection of the distal end part 50 can be reduced. Therefore, it is possible to reliably prevent the projected distal end part 51 from being positioned below the upper end of the third connecting part 35.

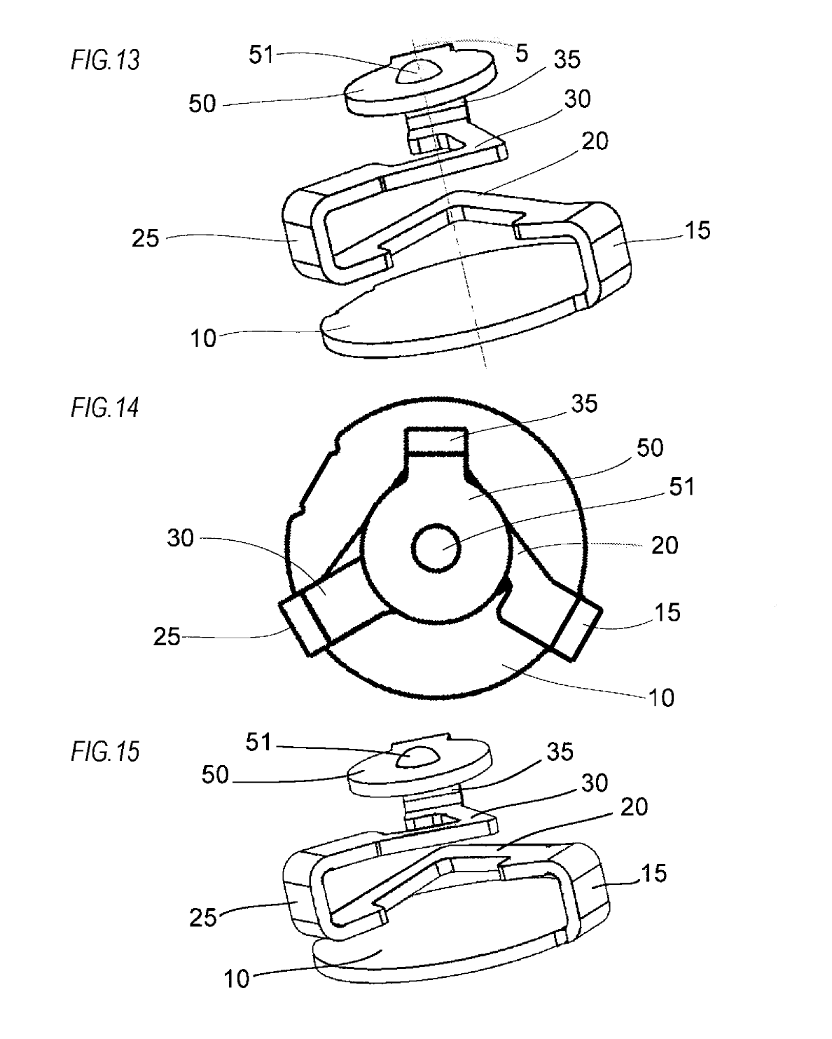

FIG. 13 is a perspective view of a connector according to Embodiment 2 of the invention, in an extended state. FIG. 14 is a plan view of the connector. FIG. 15 is a perspective view of the connector in a compressed state. It is to be noted that the cutout part 11 of the base part 10 is omitted in this embodiment and in the following embodiments.

As compared with the connector in Embodiment 1, the connector in this embodiment is substantially the same, except that the first rounding part 20 and the second rounding part 30 respectively have a triangle shape, and two rectilinear sides of the triangle shape round around the phantom line 5. In this embodiment, although a stress by torsion tends to be concentrated on an angled part between the two sides, as compared with Embodiment 1, substantially the same advantage as in Embodiment 1 can be attained in other respects.

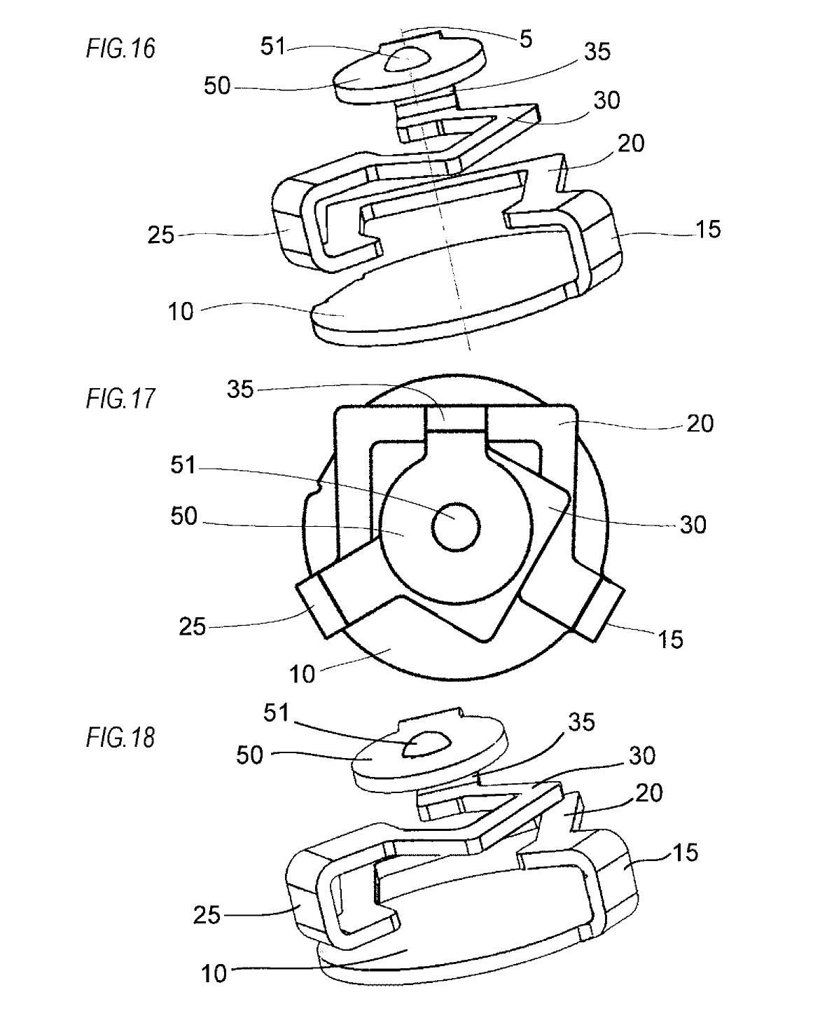

FIG. 16 is a perspective view of a connector according to Embodiment 3 of the invention, in an extended state. FIG. 17 is a plan view of the connector. FIG. 18 is a perspective view of the connector in a compressed state. As compared with the connector in Embodiment 1, the connector in this embodiment is substantially the same, except that the first rounding part 20 and the second rounding part 30 respectively have a substantially C-shape, and three rectilinear sides of the C-shape round around the phantom line 5. In this embodiment, although a stress by torsion tends to be concentrated on two angled parts between the two adjacent sides out of the three sides, substantially the same advantage as in Embodiment 1 can be attained in other respects.

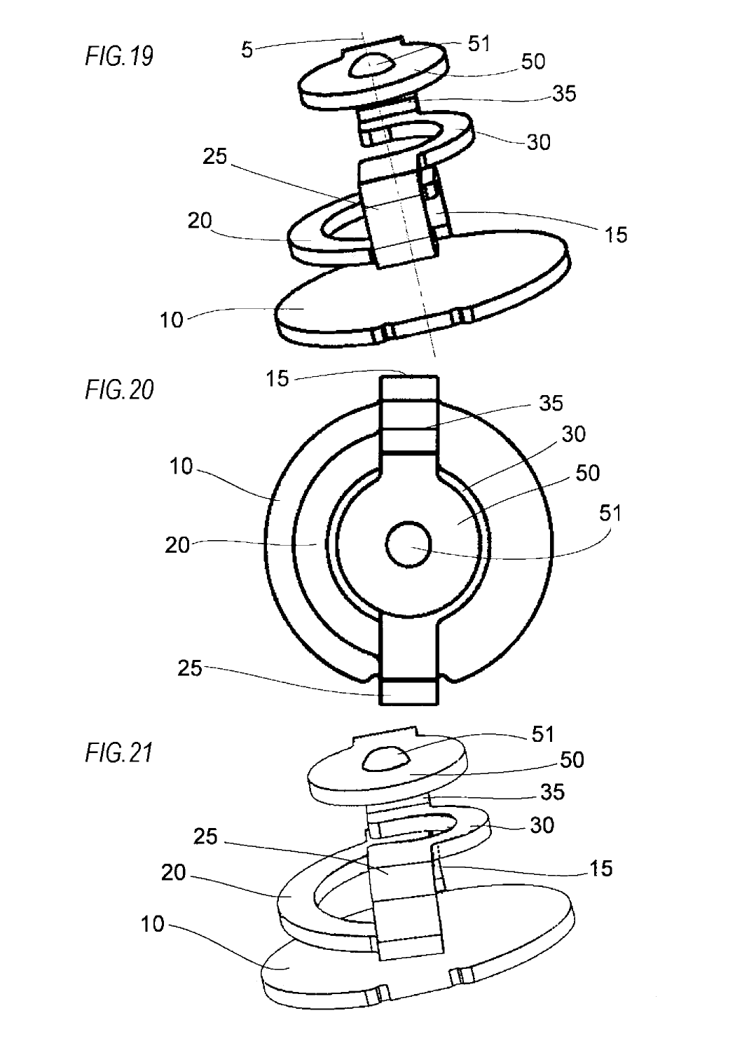

FIG. 19 is a perspective view of a connector according to Embodiment 4 of the invention, in an extended state. FIG. 20 is a plan view of the connector. FIG. 21 is a perspective view of the connector in a compressed state. As compared with the connector in Embodiment 1, the connector in this embodiment is substantially the same, except that the rounding angle of the first rounding part 20 and the second rounding part 30 is 180 degree. In this embodiment, the first connecting part 15 and the third connecting part 35 are at the same angle in a circumferential direction with respect to the direction of the phantom line 5, and therefore, Embodiment 1 is more advantageous in securing a reliable compression range. Moreover, because rounding lengths of the first rounding part 20 and the second rounding part 30 are made shorter, the elasticity by the torsion can be more easily secured in Embodiment 1. However, it is possible to achieve an advantage next to Embodiment 1, in comparing with the related-art connectors as shown in FIGS. 32, 33, although the advantage is different in degree.

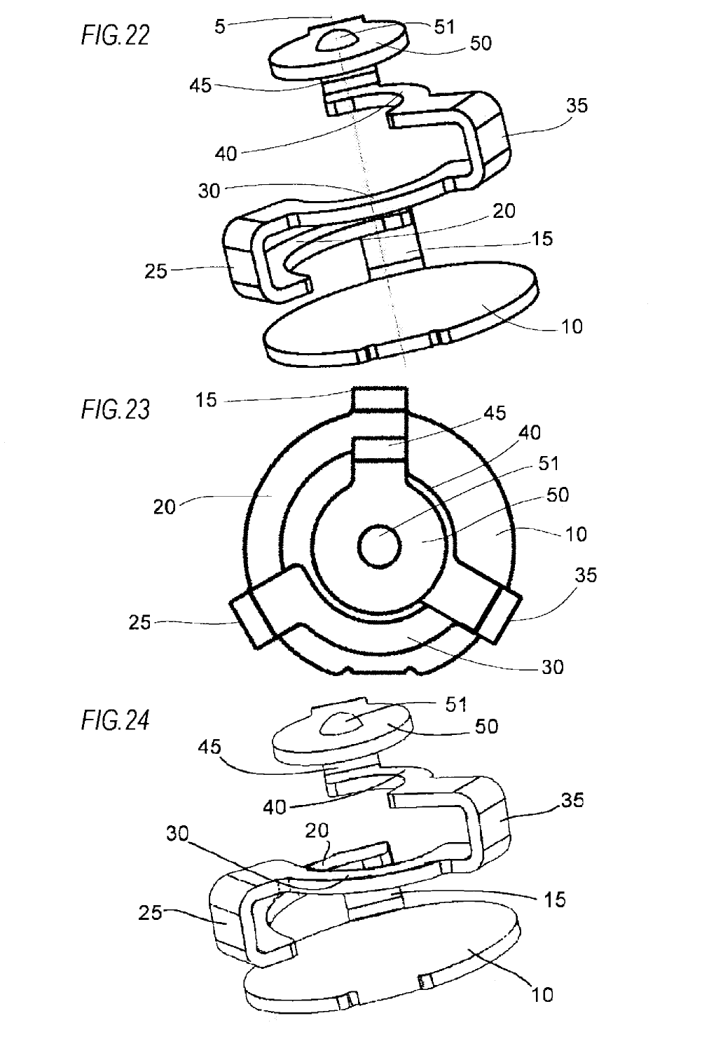

FIG. 22 is a perspective view of a connector according to Embodiment 5 of the invention, in an extended state. FIG. 23 is a plan view of the connector. FIG. 24 is a perspective view of the connector in a compressed state. As compared with the connector in Embodiment 1, the connector in this embodiment is substantially the same, except that the rounding angle of the first rounding part 20 and the second rounding part 30 is 120 degree, and that a third rounding part 40 and a fourth connecting part 45 are additionally provided.

The third rounding part 40 is extended from the bent part at the upper end of the third connecting part 35, and rounds around the phantom line 5 at the rounding angle of 120 degree, substantially perpendicularly to the phantom line 5. The fourth connecting part 45 is bent from the other end of the third rounding part 40 substantially vertically, and extended (erected) toward the distal end part 50 substantially in parallel with the phantom line 5. An upper end of the fourth connecting part is bent substantially perpendicularly, and the distal end part 50 is extended from the bent part. In this embodiment too, substantially the same advantage as in Embodiment 1 can be achieved.

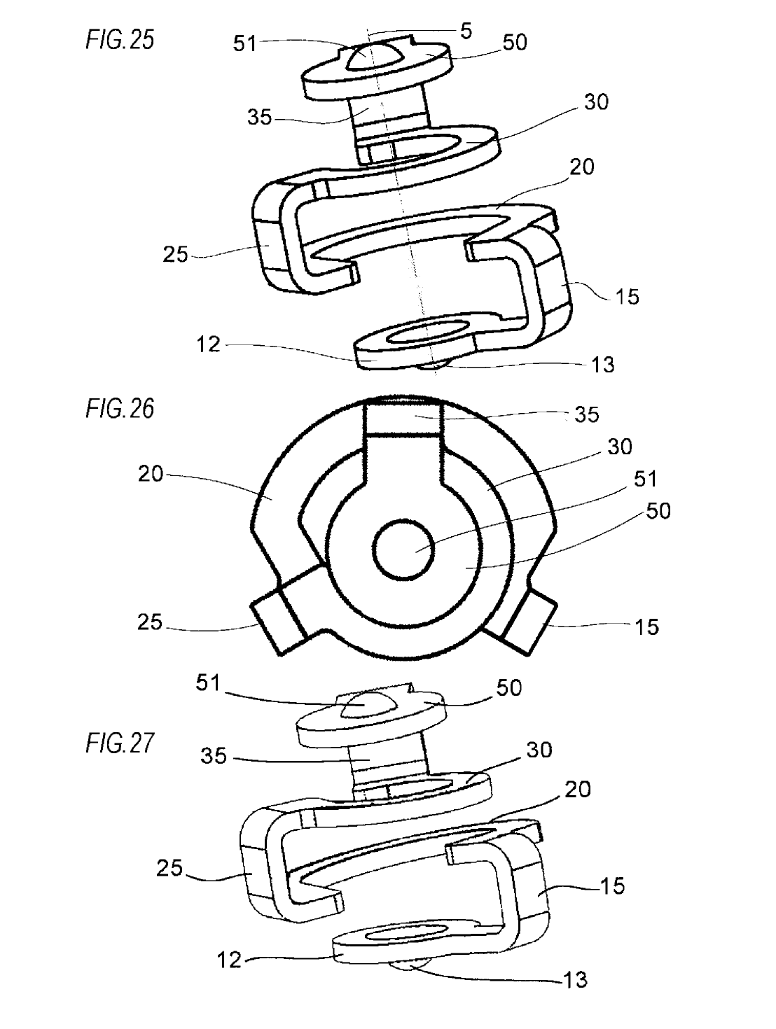

FIG. 25 is a perspective view of a connector according to Embodiment 6 of the invention, in an extended state. FIG. 26 is a plan view of the connector. FIG. 27 is a perspective view of the connector in a compressed state. As compared with the connector in Embodiment 1, the connector in this embodiment is substantially the same, except that the base part 10 is substituted with a base end part 12. The base end part 12 has a projected base end part 13 substantially in the same manner as the distal end part 50. The connector in this embodiment is of a two-pin type which is used as an unfixed contact, without fixing both the base end part 12 and the distal end part 50. In this embodiment too, substantially the same advantage as in Embodiment 1 can be achieved.

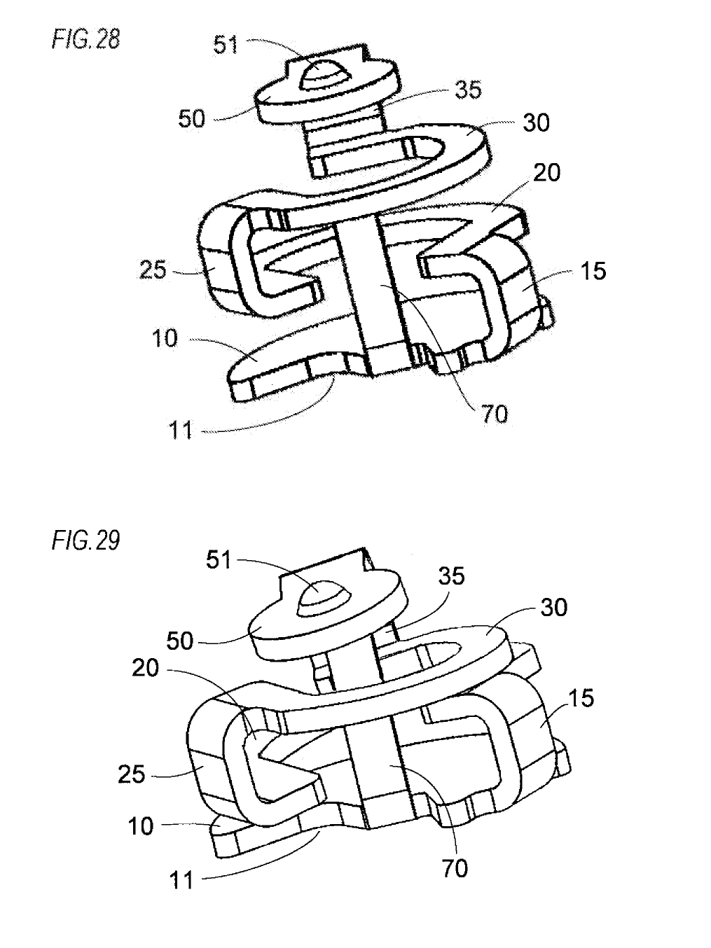

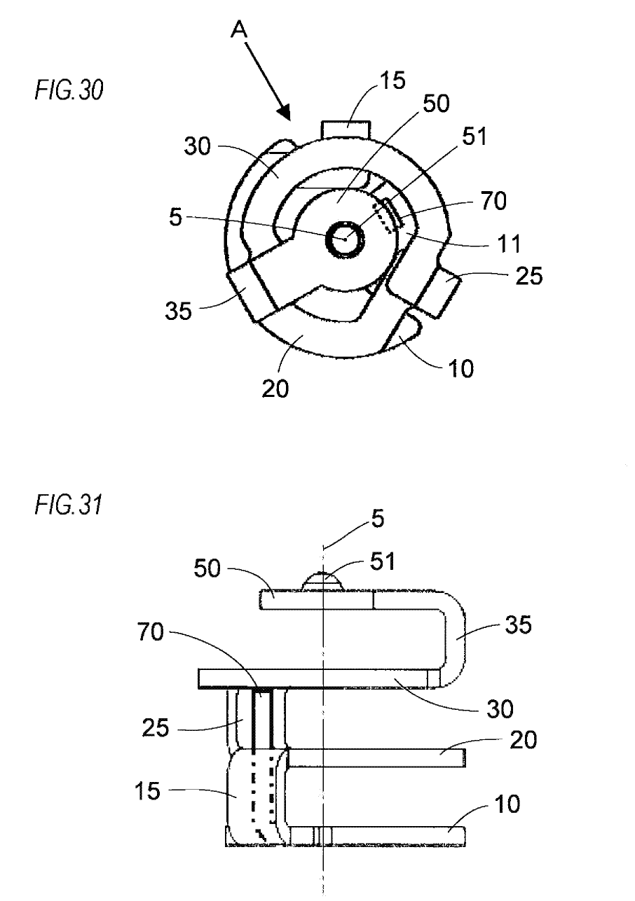

FIG. 28 is a perspective view of a connector according to Embodiment 7 of the invention, in an extended state. FIG. 29 is a perspective view of the connector in a compressed state. FIG. 30 is a plan view of the connector. FIG. 31 is a side view as seen from a direction of an arrow mark A in FIG. 30. As compared with the connector in Embodiment 1, the connector in this embodiment is substantially the same, except that a butting part 70 is erected substantially vertically from the base part 10 and extended toward the distal end part 50. The butting part 70 is in a shape of a rectangular plate, and bent substantially perpendicularly from the base part 10 to be erected substantially in parallel with the phantom line 5 with its one face directed toward the phantom line 5. As seen from the above, the butting part 70 is positioned inside the first rounding part 20 and the second rounding part 30, below the distal end part 50 (See FIG. 30). The cutout part 11 of the base part 10 is a root of erection (a starting point of folding) of the butting part 70, and a shape (or position) of the cutout part 11 is altered according to the erected position of the butting part 70.

When the connector is compressed, the butting part 70 is butted against (come into contact with) a lower face of the distal end part 50, as shown in FIG. 29. Therefore, it is possible to prevent an excessive deformation of the connector when it is compressed. Moreover, because the butting part 70 is erected substantially vertically from the base part 10, the butting part 70 will not be easily distorted, even though a high load is applied to a tip end of the butting part 70, as compared with a case where the butting part 70 is diagonally erected. Therefore, the butting part 70 can cope with a higher load. Further, a height of the butting part 70 (the height in the erected state) coincides with a lower face of the second rounding part 30 (See FIG. 31). Still further, the butting part 70 is positioned inside the first rounding part 20 and the second rounding part 30, as seen from the above, so as to be opposed to a lower face of the distal end part 50. Therefore, the connector need not be upsized for providing the butting part 70, and the space saving performance can be maintained. It is also possible to bend the tip end of the butting part 70 in parallel with the distal end part 50 toward the phantom line 5, thereby to increase a contact area with respect to the lower face of the distal end part 50 so that the butting part 70 may be reliably contacted with the lower face of the distal end part 50. An art of providing the butting part 70 in this embodiment can be also applied to Embodiments 2 to 5.

Although the invention has been heretofore described by way of the embodiments, it is to be understood by those skilled in the art that various modifications can be added to the constituent elements of the embodiments, within a scope described in claims. The modifications will be described below.

The rounding angles of the respective rounding parts are not limited to 120 degree, 180 degree, and 240 degree, but may be desired degrees less than one circle (360 degree). In this case too, it is recommended that a plurality of the rounding parts round around the phantom line 5 more than one circle.

The rounding angles of the respective rounding parts need not be the same. Specifically, the angles of the respective connecting parts in the circumferential direction with respect to the direction of the phantom line 5 as the center axis are not limited to the equiangular interval.

The layer number (the number of pieces) of the rounding parts is not limited to two layers or three layers, but may be other desired numbers. It is possible to appropriately determine the layer number of the rounding parts according to a height or so of the connector to be required.

The shapes of the respective rounding parts are not limited to the same type. For example, it is possible to make either of the rounding parts arc-shaped, and to make the other rounding parts of such a shape as rounding with two sides of a triangular shape or three sides of a C-shape.

The base part 10 in Embodiments 2 to 5 may be substituted with the base end part 12.

According to an aspect of the invention, although the connector is formed of one component at minimum, it is possible to obtain a sufficient height with a small mounting area, by securing a sufficient elasticity by means of the rounding part. As the results, both a small number of components and space saving performance can be attained at the same time.

What is claimed is:

1. A connector comprising:
a first contact part;
a second contact part; and
an elastic deformable part provided between the first and second contact parts, the elastic deformable part comprising:
at least one rounding part which rounds less than one circle around a phantom line interconnecting a base position of the first contact part and a base position of the second contact part;
a connecting part which is extended from one end of the rounding part to the first contact part; and
a connecting part which is extended from the other end of the rounding part to the second contact part.

2. The connector according to claim 1, wherein
the rounding part includes a plurality of rounding parts,
the plurality of rounding parts are arranged at different positions from each other with respect to a direction of the phantom line, and
ends of adjacent two of the plurality of rounding parts are connected by a connecting part.

3. The connector according to claim 2, wherein the plurality of rounding parts round around the phantom line more than one circle.

4. The connector according to claim 2, wherein angular positions of the connecting parts with respect to the phantom line are different from each other, as seen from the direction of the phantom line.

5. The connector according to claim 2, wherein the connecting parts are positioned at a substantially equiangular interval with respect to the phantom line, as seen from the direction of the phantom line.

6. The connector according to claim 1, wherein the rounding part rounds around the phantom line more than a half circle.

7. The connector according to claim 1, wherein
the first contact part is a base part one face of which is a mounting face,
the base part is connected to the rounding part by the connecting part which is extended from the one end of the rounding part,
the second contact part is a distal end part having a projected distal end part which is directed to an opposite side to the mounting part, and
the distal end part is connected to the rounding part by the connecting part which is extended from the other end of the rounding part.

8. The connector according to claim 7, further comprising:
a butting part which is erected from the base part and which is extended toward the distal end part, wherein the butting part is butted against a face of the distal end part, when the connector is compressed.

9. The connector according to claim 8, wherein the butting part is bent from the base part to be erected, and is positioned inside the rounding part, as seen from a direction of the phantom line.

10. The connector according to claim 7, wherein the connecting part which is extended from the other end of the rounding part has a larger width than the connecting part which is extended from the one end of the rounding part.

11. The connector according to claim 1, wherein
the rounding part exists within a plane which is substantially perpendicular to the phantom line, and
the connecting parts are bent from the rounding part to extend substantially in parallel with the phantom line.

12. The connector according to claim 1, wherein the rounding part rounds around the phantom line in a shape of an arc, making the phantom line as an axis.

13. The connector according to claim 1, which is formed by folding a sheet of conductive plate material.

14. The connector according to claim 1, wherein the phantom line interconnects a center of the first contact part and a center of the second contact part, or centers of smallest inclusion circles of contact parts with respect to objects to be contacted.
